(19) United States
(12) Patent Application Publication
(10) Pub. No.: US 2001/0053545 A1
(43) Pub. Date: Dec. 20, 2001

(54) Compost blends for use in erosion control and methods related thereto

(76) Inventor: John David Engwer, Wrenthan, MA (US)

Correspondence Address: Dike, Bronstein, Roberts & Cushman, Intellectual Property Practice Group of, Edwards & Angell, LLP, 130 Water Street, Boston, MA, 02109, US

(21) Appl. No.: 09/813,105

(22) Filed: Mar. 20, 2001

Related U.S. Application Data
(60) Provisional application No. 60/193,976, filed on Mar. 31, 2000.

(51) Int. Cl. C05F 9/04

(52) U.S. Cl. 435/262; 71/8

(57) ABSTRACT

The present invention provides innovative blends of select compost and one or more natural, organic fibrous materials that act as mechanical tackifiers. Compost blends of the present invention exhibit improved performance in landscape management, and are particularly useful in the form of mats and berms for the prevention and treatment of erosion and the control of sedimentation. They also serve to remediate water runoff of excess nutrients, pesticides, metals, and numerous other environmental pollutants.

The present application claims the benefit of U.S. provisional application No. 60/193,976, filed on Mar. 31, 2000, incorporated herein by reference.

### BACKGROUND OF THE INVENTION

1. Field of the Invention

The present invention relates to innovative blends of select compost and one or more natural, organic fibrous materials that act as mechanical tackifiers. Compost blends of the present invention exhibit improved performance in landscape management, and are particularly useful in the form of mats and berms for the prevention and treatment of erosion and the control of sedimentation. They also serve to remediate water runoff of excess nutrients, pesticides, metals, and numerous other environmental pollutants.

2. Background

Concern for our natural resources and landscapes is widespread. Preservation of the environment is essential.

Significant interest with respect to preservation of the environment has focused on general landscape management including soil erosion control, water runoff and soil movement.

Control of soil erosion is necessary regardless of the size of or the distance of a site from surface waters. Erosion control is essential to protect not only water quality but also valuable, irreplaceable soils as well.

Preventing and treating soil erosion continues to be of significant concern, worldwide. For example, within the United States alone, the Department of Agriculture reports that more than 2 billion tons of topsoil are lost through erosion every year. The soil left behind eventually becomes too poor to sustain good plant growth.

Soil which is eroded away usually is carried into wetlands, ponds, streams, lakes and rivers. The sediment itself and the associated fertilizers, pesticides and other toxic materials affect the ecological balance and health of aquatic organisms and the food chains that depend on them. This pollution also compromises the commercial, recreational and aesthetic value of waterways. As a result, preventing and treating erosion is critical for protecting the quality of water resources and for maintaining the quality and productivity of soil.

Further, although erosion is a naturally occurring process, it is greatly aggravated by construction and agricultural practices that disturb vegetation and the soil surface. The U.S. Environmental Protection Agency (EPA) continues to list storm water runoff from cities and construction sites as being one of the leading causes of poor water quality.

To reduce soil erosion and sedimentation from new construction sites and other land clearing activities, the EPA has mandated that slope stabilization and erosion and sediment control measures be employed for construction projects disturbing more than 5 acres. State and local laws commonly require the use of erosion and sediment control technologies on all construction sites.

Numerous products have been developed in an effort to control erosion and sediment. Such products include geosynthetic membranes, mats, fabrics, blankets, grids and cellular confinement systems, as well as silt fencing, hay bales, logs (or wattles) and berms. Some of these products are permanent and require removal upon completion of the project. Other systems are biodegradable to various degrees.

In addition, fiber mulch (i.e., hydromulch) and chopped hay/straw have been used in conjunction with chemical tackifiers (i.e., binders) to cover, control erosion and to apply seed to bare soil.

Despite advancements in the field, it remains highly desirable to develop improved materials and methods for landscape management, particularly in the areas of erosion control and sedimentation. It would be highly desirable for such materials to be biodegradable (no removal required) and environmentally safe. It also would be highly desirable for such materials to be easy to apply, cost effective, aesthetically pleasing, promoting of soil structure and quality, and nourishing to vegetation.

### SUMMARY OF THE INVENTION

We have discovered innovative blends of compost and various natural, organic fibrous materials that serve to mechanically/physically bind the composite together while providing porosity and water conductivity to the resulting product. Compost blends of the present invention are particularly suitable in landscape management for use as mats that prevent erosion, filter berms that control erosion and remove sediment from water runoff, substrate for revegetation of slopes, the basis of organic soil generation on inclined rocky or gravelly terrain, and a system for the bioremediation of water runoff containing excess nutrients, pesticides, metals, or numerous other environmental pollutants.

Mats and filter berms constructed in accordance with the materials and methods of the present invention hold soil and seed in place, create a microclimate that favors seed germination, reinforce the root zone to maintain vegetal cover, reduce water runoff velocities, and prevent and/or control sedimentation.

In preferred embodiments, compost of the present invention comprises a solid mature product resulting from composting, which is a managed process of biooxidation of a variety of solid organic substrates that includes a thermophilic phase. Particularly preferred materials for the production of compost include, for example, food residuals, food processing wastes, paper products, yard trimmings, animal manures and beddings, agricultural vegetable wastes, and the like.

Preferred fibrous materials for use in connection with the invention include the following: shredded tree roots or vines as well as naturally occurring organic fibrous materials such as abaca, coir, cotton, flax, jute, hemp, sisal, vines, wool, and the like.

We have surprisingly discovered that use of a fibrous mechanical tackifier in blends of the invention provides significant advantages relative to solid earth berms and other traditional barriers. For example, the mechanical tackifier promotes water filtration through the compost. Use of a mechanical tackifier in the compost blend provides an optimal consistency which is loose enough to prevent the compost from packing down, but firm enough to prevent undesirable breakthrough. Use of a tackifier in blends of the invention permits enhanced contact between the compost and water. The result is greater improve consumption of nutrients and remediation of pollutants from water, and more effective cleansing of sediment.

The specifications for compost to be used by itself as an erosion control material are provided by the leading national authority on the characterization and use of compost, the U.S. Composting Council. (See, e.g., U.S. Composting Council (1996) Field Guide to Compost Use; U.S. Composting Council (1996) Suggested Compost Parameters & Compost Use Guidelines.)

Compost blends of the present invention are environmentally friendly. They utilize organic materials, including recycled organic materials, which significantly enhance soil quality and the nutrient supply to plants. Berms of the present invention are also navigable to turtles, salamanders, and other animals (conventional silt fences/straw bales prevent this). Additionally, berms of the present invention naturally remove pollutants such as excess plant nutrients, pesticides, heavy metals, and petroleum-based substances in water leaching off of roadways, agricultural and industrial land, turf intensive areas (e.g., athletic fields, golf courses, etc.), and residential properties.

Other benefits, especially of compost-blended mats, include decreased water runoff (corresponds to increased infiltration and available water for seed and plant establishment) and decreased settleable/suspended solids (corresponds to increased soil remaining on slopes and not in waterways).

Compost-blended filter berms of the present invention are cost efficient. For example, minimal materials are needed, and labor/time consumption is significantly reduced as compared to traditional berm construction and installation.

Compost-blended mats and filter berms of the invention are easily installed. No clean up or removal is necessary. Compost filter berms of the invention are preferably applied with a compressed-air blower system as will be appreciated by those skilled in the art. Such a system typically comprises an applicator hose connected to a holding area/reservoir (e.g., on a truck). In that way, projects can be completed much faster. No heavy equipment needs to travel on the terrain where the mats or berms are to be installed, thus decreasing compaction of existing soils or the destruction of existing vegetation. The applicator hose can reach hard to access areas and can extend to 500 ft or more.

Further, vegetation grows from the berm, maintaining a natural appearance. It fits into the natural landscape in many situations. This presents a tremendous savings in terms of labor compared to traditional materials such as straw bale/filter fabrics which need to be collected after the project is completed. Additionally, straw bale/filter fabrics are wasted, e.g., disposed of rather than reused, adding unnecessary materials to landfills.

Compost-blended filter berms of the present invention may be applied in areas where water has already accumulated. Berms of the invention may be constructed on substantially level areas or on slopes of varying degrees. Also, if a more level area is desired on any given slope, the berm may be applied in a more spread out fashion. In that way, the berm also lessens the degree of the slope, further slowing the velocity of water runoff.

Compost-blended filter berms of the present invention are aesthetically pleasing. For instance, vegetation adds greenery to the landscape, contrary to the barrenness caused by erosion and the unattractiveness of hay bales/silt fence. Additionally, berms of the invention are not limited to traditional designs, as the compost blends may be blown in to a target site in any of a number of configurations.

Other aspects of the invention are discussed infra.

### BRIEF DESCRIPTION OF DRAWINGS

FIG. 1 shows a compost-blended filter berm constructed on a slope in a preferred embodiment of the invention.

FIG. 2 shows multiple compost-blended filter berms in an alternate preferred embodiment of the invention.

### DETAILED DESCRIPTION OF THE INVENTION

As noted above, erosion control and sedimentation have become major environmental concerns. It is critical that we reduce pollution and manage our landscapes more effectively. The primary forces of erosion include wind and water. These forces create conditions that are destructive to the environment.

We have discovered innovative compost blends with mechanical tackifiers which are all natural organic materials. Blends of the present invention are suitable for use in landscape management, particularly in erosion and sediment control and the bioremediation of pollutants in water runoff.

Additionally, the organic materials utilized for blends of the invention may comprise a variety of recycled materials, thereby presenting a further environmental advantage.

In preferred embodiments, compost of the present invention comprises a solid mature product resulting from composting, which is a managed process of biooxidation of a variety of solid organic substrates that includes a thermophilic phase. Particularly preferred materials for the production of compost include, for example, food residuals, food processing wastes, paper products, yard trimmings, animal manures and beddings, agricultural vegetable wastes, and the like.

Suitable compost products are chosen in view of the U.S. Composting Council's guidelines for compost used by itself to control soil erosion (U.S. Composting Council (1996) Field Guide to Compost Use; U.S. Composting Council (1996) Suggested Compost Parameters & Compost Use Guidelines).

To perform the selection, compost from a variety of sources and producers is tested to ensure its suitability. A variety of commercial certified laboratories are available for such testing as will be appreciated by those skilled in the art. These laboratories adhere to the analytical procedures recommended by the U.S. Composting Council and published in “Test Methods for the Examination of Composting and Compost” (1997).

We specify the following compost parameters in accordance with the guidelines developed by the U.S. Composting Council: levels of regulated chemicals; pathogens; viable weed seeds; man-made inerts; particle size and texture; biological stability; maturity; phytotoxicity (growth screening); germination and growth; bulk density; moisture content; organic matter content; ash content; pH; soluble salt content (electrical conductivity); and total salt content. Also, in accordance with the specifications established by the U.S. Composting Council, plant nutrient content is considered in terms of nitrogen (organic, ammonium and nitrate nitrogen); phosphorus; potassium; secondary nutrients (calcium, magnesium, sulfur, and sodium); micronutrients (zinc, iron, manganese, copper, and boron); organic matter carbon; carbon-to-nitrogen ratio; free air space; drainage, infiltration and permeability; hydraulic conductivity; and water holding capacity.

Preferred fibrous materials for use in connection with the invention include the following: shredded tree roots or vines as well as naturally occurring organic fibrous materials such as abaca, coir, cotton, flax, jute, hemp, sisal, vines, wool, and the like.

We have surprisingly discovered that use of a fibrous mechanical tackifier in blends of the invention provides significant advantages relative to solid earth berms and other traditional barriers. For example, the mechanical tackifier promotes water filtration through the compost. Use of a mechanical tackifier in the compost blend provides an optimal consistency which is loose enough to prevent the compost from packing down, but firm enough to prevent undesirable breakthrough. Use of a tackifier in blends of the invention permits enhanced contact between the compost and water. The result is greater consumption of nutrients and remediation of pollutants from water, and more effective cleansing of sediment.

It will be appreciated that the proportion of organic compost to mechanical tackifier (the natural, organic fibrous material) will vary widely depending on the specific needs of the situation, but may readily be determined empirically by one skilled in the art based on the present disclosure. It is generally preferred that the compost to mechanical tackifier be in the range of about 25:75 (v:v) to about 50:50 (v:v).

Other variables which can be readily determined by those skilled in the art based on the present disclosure include the degree of porosity, amount of physical interlacing of the compost required, the fineness of the kind of fiber used, and the like.

Compost-blended mats and filter berms constructed in accordance with the present invention are a particularly effective method of preventing and controlling precious soils from wearing away. Further, compost-blended filter berms of the invention prevent unwanted chemicals from leaching into our wetlands and waterways.

Compost-blended mats and filter berms of the invention may be constructed in areas where erosion already has become a problem or in areas which are vulnerable to erosion in the future. Construction on slopes of varying degrees is feasible using blends and methods of the present invention. In some instances, construction of multiple berms will be desirable, e.g., a first berm built at the bottom of a slope and a second berm built at the top of the slope.

Compost blends of the invention can be blown in to the target site in a variety of configurations. For example, it may be blown in to create a mound (i.e., berm), between about 1 and 10 feet in width, more preferably between about 3 and 4 feet in width; and between about 1 and 5 feet in height, preferably about 1 to 2 feet in height. Lengths of the berms are indefinite depending on the situation. Compost blends of the invention can also be blown in as mats that will take on the configuration of the slope. Blends of the invention may be blown onto preexisting ground or into areas where water has accumulated.

The installation of compost-blended filter berms of the invention control and eradicate the effects of erosion by acting as a sieve. As the water runoff and sediment flow through the compost mixture, the microorganisms in the compost degrade pollutants and contaminants such as hydrocarbons and other algae promoting substances. Compost blends of the invention retain sediments and moisture, continuously replenishing the organic matter necessary in completing decomposition. This process results in less settleable and soluble solids, and prevents chemicals and undesirable sediment from reaching our water supplies.

Compost-blended filter berms of the present invention are environmentally friendly in comparison to other methods of erosion control such as silt and sediment fences and staked straw/hay bales. Berms of the present invention are completely natural, organic, and aesthetically pleasing as well. Berms of the present invention do not require removal once the project has been completed. Indeed, the berms may stay in place as long as desired.

Compost blends of the invention can be used in constructing compost filter berms with ease and efficiency using a blower system/applicator hose as will be appreciated by those skilled in the art.

Also, though blends of the invention are rich in slow release forms of nitrogen, phosphorus, potassium and other nutrients, they do not release these nutrients into the surrounding environment. When used to control storm water runoff and erosion, they assimilate these materials and prevent water pollution. The compost blends of the invention not only are effective soil nutrient management tools, they are pleasing to the eye as well.

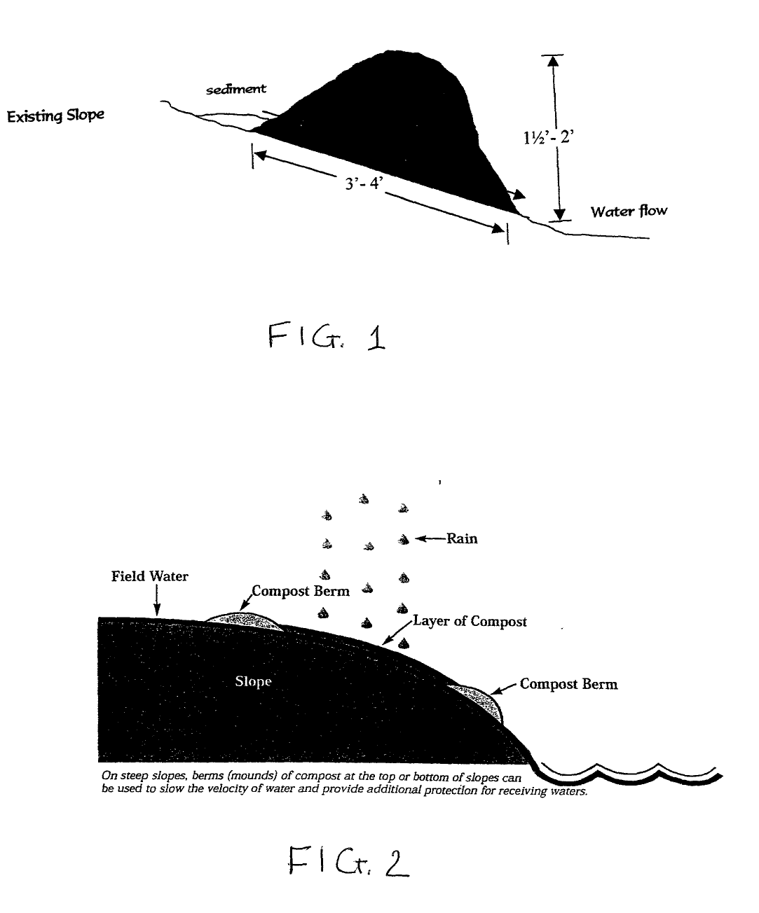

Referring to FIG. 1, a compost filter berm constructed in accordance with the present invention is shown on a slope. As shown, the compost filter berm acts as a natural water and sediment filter. As soil and water runoff enter the berm, microorganisms living in the compost degrade and decompose hazardous and harmful materials, while absorbing water.

Referring now to FIG. 2, the use of multiple compost berms (mounds) are shown. For example, on particularly steep slopes, compost berms of the invention can be used at the top and/or bottom of the slope to slow the velocity of water and provide additional protection for receiving waters.

The use compost filter berms of the invention for erosion control allows less sediment and chemicals to leach into waterways. Further, the use of compost blends of the invention for amending native soils improves organic matter content and reduces the ability of that soil to erode. Blends of the invention also improve seed establishment and plant growth, further reducing soil erosion.

Compost filter berms of the invention can be used in place of traditional silt fences and straw bales at a lower cost while providing safer and more environmentally stable conditions for animals in and around our landscapes.

The foregoing description of the invention is merely illustrative thereof, and it is understood that variations and modifications can be made without departing from the spirit or scope of the invention as set forth in the following claims. Further, all references cited herein are incorporated by reference.

What is claimed is:

1. A compost blend for use in erosion control, sedimentation, and remediation comprising:
(a) one or more organic compost materials, and
(b) one or more fibrous materials.

2. The compost blend of claim 1, wherein the organic compost material comprises recycled organic materials.

3. The compost blend of claim 1, wherein the blend comprises a ratio of organic compost material to fibrous materials of about 25:75 (v:v).

4. The compost blend of claim 3, wherein the blend comprises a ratio of organic compost material to fibrous materials of about 50:50 (v:v).

5. A filter mat or berm comprising the compost blend of claim 1.

6. A method for managing landscapes comprising:
(a) providing a compost blend comprising one or more organic compost materials, and one or more fibrous materials; and
(b) applying the compost blend to a target site.

7. The method of claim 6, wherein the compost blend is blown or otherwise spread onto the target site.
